(19) United States
(12) Patent Application Publication
(10) Pub. No.: US 2006/0258796 A1
(43) Pub. Date: Nov. 16, 2006

(54) Crosslinked polyethylene compositions

(75) Inventors: Louis Boogh, Meyrin (CH); Martin Storb, Meyrin (CH); Abdellatif Abderraziaq, Meyrin (CH); Patrice Lehmann, Meyrin (CH)

Correspondence Address: General Electric Advanced Materials - Silicones, Bldg. 769 - Suite 300, 771 Old Saw Mill River Road, Tarrytown, NY, 10591, US

(73) Assignee: General Electric Company

(21) Appl. No.: 11/128,603

(22) Filed: May 13, 2005

(51) Int. Cl. C09B 67/00

(52) U.S. Cl. 524/502; 525/342

(57) ABSTRACT

A method for making a polymer blend includes blending a thermoplastic polymer, a grafted polyolefin, a moisture source, and a crosslinking agent in a mixing zone to provide a thermoplastic polymer blend including a matrix phase of the thermoplastic polymer, a reinforcing phase of the at least partially crosslinked polyolefin, and having a gel content of from about 10% to about 50% by weight.

### BACKGROUND OF THE INVENTION

Plumbing and heating pipe systems operate at pressures between 2 and 10 bar and at temperatures up to 90° C. as described in ISO-10508. Traditionally, such pipes have been manufactured out of copper or galvanized steel. These materials are however subject to corrosion and are cumbersome and costly to install and to maintain. As a result, many polymeric based materials have in the past decades been replacing these metals because of their flexibility, ease of installation as continuous pipes, their light weight and ease with which they can be fusion welded. Of the polymeric materials, polyethylene would be the favored material because it is more inert, environment friendly, flexible and has a higher thermal conductivity and better economics than other polymers.

However, polyethylenes cannot be used without crosslinking to achieve the needed thermo-mechanical properties, in particular the long term hydrostatic strength, for such applications. The drawback with crosslinking techniques currently being employed, i.e., through peroxide, silane or irradiation techniques, is that these are all costly due to limited processability and/or required post-forming treatments. Furthermore, these crosslinking techniques involve chemical reactions which adversely affect long-term stability of the final products and the organoleptic properties of the polymer. This is mainly due to side reactions affecting the stabilizer packages and the generation of reaction by-products. Finally, unlike the non-crosslinked thermoplastic piping material, the crosslinked polyethylenes have limited capacity to be fusion welded.

Crosslinked polyethylene, despite the drawbacks mentioned above, is currently one of the leading plastic materials used.

To achieve the required thermo-mechanical properties for plumbing and heating pipe applications with polyethylene materials, crosslinking has been required. Three main crosslinking techniques have been developed: peroxide crosslinking, silane crosslinking, and irradiation crosslinking. The applicability of the crosslinked polyethylene materials, regardless of their processing method, has been described in EN ISO-15875. In this norm a requirement for the crosslinked polyethylene materials is to have a minimum crosslinking degree as measured by its gel content, which needs to be above 60% at the least.

More recently, molecular architecturing of polyethylenes has been used to enhance the intrinsic thermo-mechanical properties of the polymers. These developments, related to new polymer synthesis techniques, allowed the controlled introduction of octene co-monomers, thereby producing a performance-enhanced polyethylene of high molecular weight with 6 carbon pendant chains arranged in an optimized manner to contribute to the performance of the polymer. These pendant chains, increasing the amount of physical entanglements and of tie-molecules that are formed during solidification, thus lead to increased strength under long-term stresses and creep resistance. These materials defined in ISO-1043-1 as PE-RT (polyethylene of raised temperature resistance) have been accepted for use in hot water pipe applications as described by ISO-10508. The advantages of these materials are that, not being crosslinked, they are recyclable and can be welded, and do not require a post-forming crosslinking operation. These materials however do not achieve by far the thermal strength and creep resistance of crosslinked polyethylenes and can thus present some limitations in their applicability under conditions encountered in practice.

Partial crosslinking of polyethylenes has been shown in the past to increase the mechanical performances as described in for example U.S. Pat. No. 4,226,905. This patent discloses that the tear strength of a blown film can be improved by partially pre-crosslinking the base polyethylene using any known crosslinking method using chemical crosslinking agents or physical irradiation methods.

More recently, WO03089501 describes similarly the increase in hydrostatic strength obtained by irradiation of a polyethylene prior to forming. The irradiation results in a modification of the molecular weight and molecular weight distribution as described and probably also in a partial crosslinking although this latter fact is not verified. In any case, it is clear from the patent description that a minimum irradiation is necessary to enhance properties, but that one cannot apply high irradiation doses if processability is to be maintained.

Partial crosslinking has also been used for inducing shape memory to manufactured polyethylene based parts such as shrinking sleeves. In this case, the extent of partial crosslinking generally requires 25 to 40% of gel content to be reached to achieve the shape memory and shrinkage effects obtained on products reheated after initial heat-deformation of crosslinked parts. Such parts can be crosslinked using any known crosslinking method using chemical crosslinking agents or physical irradiation methods. After crosslinking, these products can only be deformed proportionally to their original shape, but cannot be reprocessed or recycled due to the high gel contents. This example nevertheless demonstrates that thermal resistance of polyethylenes can be increased as exemplified through the shape memory effects occurring at melting temperatures of the base resins, but at the expense of processability.

All the above examples of partial crosslinking have in common the fact that 100% of the resin in the compounds is treated to achieve the levels of crosslinking required for the relevant applications mentioned. In this way, crosslinking thus results in achieving a compromise between mechanical, thermal and processing properties. Achieving the required thermo-mechanical and processability properties required to shape the products is thus not possible using these approaches.

Crosslinking of polymer blends is also performed in the so-called thermoplastic vulcanizates (TPV) technology. See, for example, Schonbourg et al. U.S. Pat. No. 6,448,343, which is herein incorporated by reference, for a description of such technology. Such materials are comprised of thermoplastic matrices in which are included crosslinked thermoplastic or rubber particles. The chemical nature of both phases, apart from the fact that one is crosslinked and not the other, are generally of different nature, the rubber phase being used to induce flexibility, and the matrix being chosen for best therrno-mechanical performances. The fact that these are of different nature is also related to the process used to manufacture these, generally based on a dynamic crosslinking technology. Many material combinations and crosslinking technologies can be used and are known in the art. The crosslinking allows increasing the thermo-mechanical performances of the crosslinked phase, generally higher flexibility but lower strength than the matrix material. This in turn allows improved flexibility, compression set and creep properties of the compound compared to the performances of the base resin, yet maintaining its processability. Such performance combinations are different than what is sought for in pipe applications. Furthermore, the material combinations used in the standard TPV technologies, due in many cases to the processing constraints needing a base polymer for the crosslinked phase more prone to reaction than the matrix resin, are not suited for hot water plumbing and heating pipe applications.

What is needed is a polyethylene composition which is suitable for use as a fabrication material for piping systems, yet avoids the disadvantages of the crosslinked polyethylene as mentioned above.

### SUMMARY

A method for making a polymer blend is provided herein. The method includes blending a thermoplastic polymer, a grafted polyolefin, a moisture source, and a crosslinking agent in a mixing zone to provide a thermoplastic polymer blend including a matrix phase of the thermoplastic polymer, a reinforcing phase of the at least partially crosslinked polyolefin, and having a gel content of from about 10% to about 50% by weight.

The polymer composition solves the above mentioned drawbacks of crosslinked polyethylene, in particular the need for a cost inducing crosslinking and/or post-forming treatment, the long-term stabilization difficulties and the weldability. The crosslinking of polyethylene compositions, when achieved under well controlled conditions as described herein, provides the required properties for tubular conduits for hot water plumbing and heating pipe applications as well as for district heating, gas and industrial pipes.

### DETAILED DESCRIPTION OF PREFERRED EMBODIMENT(S)

The new process technology described herein allows manufacturing of partially or fully crosslinked polymers close to the TPV technology characterized by the fact that the matrix and crosslinked polymers can be made of base resins of similar nature and/or of similar reactivity towards the crosslinking chemicals used. It is such materials that have been found to be suitable for hot water, gas and industrial pipe applications. These materials have excellent thermal and mechanical properties and only require a minimum amount of reactants to achieve crosslinking favorable for the organoleptic properties compared to standard crosslinked polyethylenes. The properties obtained approach those of crosslinked polyethylene pipes with the additional benefits of being weldable and recyclable because of their thermoplasticity.

In one embodiment the present invention combines a thermoplastic polymer used as a matrix phase with a partially or fully crosslinked polymer such as polyethylene or other polyolefin (homopolymer or copolymer) for use as a reinforcing phase in a polymer blend. Both polymers can be made out of the same base resin, but preferably differ slightly in their densities and/or viscosities. These differences facilitate the formation of a crosslinked phase within the thermoplastic matrix through the dynamic processes described below.

More particularly, in one embodiment the polymer composition of the invention has a gel content preferably of from about 10% to about 50% by weight, in another embodiment from about 15% to about 40% by weight, and yet in another embodiment from about 20% to about 30% by weight.

In one embodiment the polymer composition of the invention includes from about 1% to about 75% by weight of the matrix phase thermoplastic polymer and from about 25% to about 99% by weight of the reinforcing phase partially or fully crosslinked polyolefin, in another embodiment from about 10% to about 60% by weight of the matrix phase thermoplastic polymer and from about 40% to about 90% by weight of the reinforcing phase partially or fully crosslinked polyolefin, and in yet another embodiment from about 20% to about 50% by weight of the matrix phase thermoplastic polymer and from about 50% to about 80% by weight of the reinforcing phase partially or fully crosslinked polyethylene.

In one embodiment, the reinforcing phase raw material includes a material partially or fully pre-crosslinked prior to compounding, for example by chemical crosslinking or radiation treatment, but crosslinking is preferably achieved dynamically during the final stages of compounding by the introduction of a crosslinker and/or a crosslinking catalyst. Suitable crosslinking agents include silanes (aminosilanes, vinylsilanes, vinylaminosilanes, and the like) and organic diamines such as, hexamethylene diamine and the like. Pre-crosslinking prior to compounding can be achieved using any method applicable to crosslinking of polyethylene resins. Dynamic crosslinking can be achieved using pre-grafted polyethylene resins to which, during compounding, a suitable crosslinker and/or crosslinking catalyst is added. Pre-grafted resins can be copolymers such as ethylene-vinylsilane copolymers or can comprise a polyethylene resin to which vinylsilanes, maleic-anhydride, epoxy or amine moieties or the like, have been grafted using peroxides. The vinylsilanes, maleic-anhydride, epoxy or amine moieties are capable of being reacted using agents such as, for example, water or other moisture source and/or a catalyst such as a tin compound. The water can be introduced as such or using any solid or liquid carrier that would contain sufficient water to achieve crosslinking when used with vinylsilane copolymers or vinylsilane grafted polyethylene resins. Water can also be introduced by any material that would liberate or produce water at the temperatures used for processing the compound, such as, e.g., hydrates of inorganic compounds such as inorganic hydrates (e.g., Mg(OH)₂, Ca(OH)₂, Al(OH)₃, etc.) or other inorganic compounds. In the case of other reactive moieties grafted polyethylenes, any suited chemical crosslinking agent can be chosen that would induce crosslinking.

Both or one of the resins can further be pre-compounded separately with UV stabilizers (e.g., Irganox 1076 and 1010 manufactured by Ciba Geigy Co., BHT, etc.), pigments (e.g., titanium white, carbon black, etc.), fillers, processing aids (e.g., calcium stearate, zinc stearate, lithium stearate, etc.) or any other additive of known art relevant to achieve desired further property tailoring. The above mentioned additives can also be introduced during compounding prior to or after crosslinking, or in the partially crosslinked compounded product during product shaping.

A preferred method of preparation can be performed in a single process in a batch or continuous compounding equipment, such as a Banburry mixer, a twin screw extruder or a Buss kneader. In one embodiment the following components are successively introduced into the compounding equipment: (a) the polyolefin (e.g., polyethylene) to be used as the reinforcing phase and the grafting chemicals, such as a free radical generator (e.g., peroxide) and carboxylic acid anhydride (e.g., maleic anhydride), for a grafting step, (b) then the thermoplastic polymer (e.g., polyethylene, polypropylene, etc.) to be used as a matrix and the stabilizers and other additives as mentioned above for a blending step are introduced, (c) then the crosslinking additive(s) (e.g., silane, or organic diamines such as hexamethylene diamine) and/or crosslinking catalyst(s) for a partial crosslinking step are introduced. The final compound is then either discharged or pelletized to be used in either a standard extruder for continuous profile shaping such as a pipe, or an injection molding equipment for producing shaped parts such as fittings.

In an embodiment of the invention the polymer to be used as the partially or fully crosslinked reinforcing phase is polyethylene.

Suitable thermoplastic polymers (a) include, but are not limited to, polypropylene (PP); polyethylene, especially high density (PE); polystyrene (PS); acrylonitrile butadiene styrene (ABS); styrene acrylonitrile (SAN); polymethylmethacrylate (PMMA); thermoplastic polyesters (PET, PBT); polycarbonate (PC); and polyamide (PA) and polyphenylene ether (PPE) or polyphenylene oxide (PPO). In one embodiment the matrix thermoplastic polymer is polyethylene and/or polypropylene. The matrix polymer and the crosslinked polymer can be the same or different.

In one embodiment the reinforcing phase polymer is crosslinked prior to blending with the matrix phase thermoplastic polymer. In another embodiment, when the matrix polymer and reinforcing phase polymer are the same, for example, the carboxylic anhydride and free radical generator can be added to the polymer composition as a whole. When the silane is added part of the polymer forms the crosslinked phase while another part remains as the thermoplastic matrix phase, given the controlled amount of anhydride and silane present. It is desirable to have a proper degree of phase separation between the two phases. This process can be accomplished in a single continuous mixer, two or more mixers in tandem, a batch mixer or other mixer suitable for the purposes described herein.

Suitable carboxylic anhydrides for use in the process of the invention can include, for example, any carboxylic acid anhydride which can be grafted onto the polymer to be the rubber phase by any possible mechanism. It is preferable, that there be an unsaturation either in the polymer, or more preferably, in the acid anhydride, to accomplish this grafting. The unsaturation of the carboxylic acid anhydride may be internal or external to a ring structure, if present, so long as it allows for reaction with the polymer. The acid anhydride may include halides. Mixtures of different carboxylic acid anhydrides may be used. Exemplary unsaturated carboxylic acid anhydrides for use in the present invention include, but are not limited to, isobutenylsuccinic, (±)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic, bromomaleic, and dichloromaleic anhydrides.

The amount of carboxylic anhydride is selected so as to provide the desired degree of crosslinking. Generally, the composition includes from about 0.01 wt % to about 1.0 wt % of the carboxylic anhydride. In another embodiment the composition includes from about 0.05 wt % to about 0.5 wt % of the carboxylic anhydride. In yet another embodiment the composition includes from about 0.05 wt % to about 0.2 wt % of the carboxylic anhydride.

Suitable free-radical generators may be selected from the group of water soluble or oil soluble peroxides, such as hydrogen peroxide, ammonium persulfate, potassium persulfate, various organic peroxy catalysts, such as dialkyl peroxides, e.g., diusopropyl peroxide, dilauryl peroxide, di-t-butyl peroxide, di(2-t-butylperoxyisopropyl)benzene, 3,3,5-trimethyl 1,1-di(tert-butyl peroxy)cylohexane; 2,5-dimethyl-2,5-di(t-butylperoxy)hexane, 2,5-dimethyl-2,5-di(t-butylperoxy)hexyne-3; dicumyl peroxide, alkyl hydrogen peroxides such as t-butyl hydrogen peroxide, t-amyl hydrogen peroxide, cumyl hydrogen peroxide, diacyl peroxides, for instance acetyl peroxide, lauroyl peroxide, benzoyl peroxide, peroxy ester such as ethyl peroxybenzoate, and the azo compounds such as 2-azobis(isobutyronitrile). In an embodiment, the free radical generator is present in an amount of about half that of the carboxylic anhydride, although greater or lesser amounts can be employed when appropriate.

Suitable silanes for use herein are preferably aminosilanes having at least one hydrolyzable group, e.g., alkoxy, acetoxy or halo, preferably alkoxy. Preferably, there are at least two such hydrolyzable groups capable of undergoing crosslinking condensation reaction so that the resulting compound is capable of undergoing such crosslinking. A mixture of different aminosilanes may be used.

The silane may be represented by the formula YNHBSi(OR)ₐ (X)₃₋ₐ, wherein a=1 to 3, preferably 3, Y is hydrogen, an alkyl, alkenyl, hydroxy alkyl, alkaryl, alkylsilyl, alkylamine, C(═O)OR or C(═O)NR, R is an acyl, alkyl, aryl or alkaryl, X may be R or halo. B is a divalent bridging group, which preferably is alkylene, which may be branched (e.g. neohexylene) or cyclic. B may contain heteroatom bridges, e.g., an ether bond. Preferably B is propylene. Preferable R is methyl or ethyl. Methoxy containing silanes may ensure a better crosslinking performance than ethoxy groups. Preferably, Y is an amino alkyl, hydrogen, or alkyl. More preferably, Y is hydrogen or a primary amino alkyl (e.g., aminoethyl). Preferable X are Cl and methyl, more preferably methyl. Exemplary silanes are gamma-amino propyl trimethoxy silane (SILQUEST® A-1110 silane from GE); gamma-amino propyl triethoxy silane (SILQUEST® A-1100); gamma-amino propyl methyl diethoxy silane; 4-amino-3,3-dimethyl butyl triethoxy silane, 4-amino-3,3-dimethyl butyl methylediethoxysilane, -beta-(aminoethyl)-gamma-aminopropyltrimethoxysilane (SILQUEST® A-1120), H₂NCH₂CH₂NHCH₂CH₂NH(CH₂)₃Si(OCH₃)₃ (SILQUEST® A-1130) and N-beta-(aminoethyl)-gamma-aminopropylmethyldimethoxysilane (SILQUEST® A-2120). Other suitable amino silanes are as follows: 3-(N-allylamino)propyltrimethoxysilane, 4-aminobutyltriethoxysilane, 4-aminobutyltrimethoxysilane, (aminoethylaaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl]ethylenediamine, N-methylaminopropyltrimethoxysilane, bis-(gamma-triethoxysilylpropyl)amine (SILQUEST® A-1170), N-ethyl-gamma-aminoisobutyltrimethoxysilane (A-LINK 15), 4-amino-3,3-dimethylbutyltrimethoxysilane (SILQUEST® A-1637), 4-amino-3,3-dimethylbutyldimethoxysilane (SILQUEST® A-2639) and N-phenyl-gamma-aminopropyltrimethoxysilane (SILQUEST® Y-9669).

The aminosilane should be present at 250 to 25,000 ppm based on weight of both polymers. It should also be present at a molar equivalency ratio to the acid anhydride of about 0.1 to 10, more preferably 0.9 to 1.1, most preferably, about a 1:1 ratio.

In an embodiment of the invention, the silane can be carried on a carrier such as a porous polymer, silica, titanium dioxide or carbon black so that it is easy to add to the polymer during the mixing process. Exemplary such material are ACCUREL polyolefin (Akzo Nobel), STAMYPOR polyolefin (DSM) and VALTEC polyolefin (Montell), SPHERILENE polyolefin (Montell), AEROSIL silica (Degussa), MICRO-CEL E (Manville) and ENSACO 350G carbon black (MMM Carbon).

The examples below illustrate the invention except for those designated as Comparative which are presented for comparison purposes only. Composition percentages are by weight unless otherwise indicated and are based on the total weight of the polymer blend. Gel content is measured by standardized test EN579. The following processes are employed in the examples.

Process 1:

A partially crosslinked composition is prepared using a Brabender internal mixer regulated at 200° C. The Brabender mixing head of a volume of 50 cm³ is equipped with Banbury knives set at a rotation speed of 120 rpm. The process is performed in a single step by introducing all components at the same time. To homogenize the mixture, the components are premixed in a bag prior to their introduction. The process is run until the torque is stabilized and the crosslinking reaction has been completed (ca. 10 min). The composition is then recovered and pressed into 1.5 mm thick plaques at 190° C. and under 100 bars for 1 min in a Colin hot press.

Process 2:

A partially crosslinked composition is prepared using a Brabender internal mixer regulated at 200° C. The Brabender mixing head of a volume of 50 cm³ is equipped with Banbury knives set at a rotation speed of 120 rpm. The process is performed in 3 successive steps, where first the resin to be crosslinked is introduced with the peroxide and maleic anhydride, this grafting reaction is run for a predetermined period of time (e.g., 5 min); then the matrix resin is introduced and mixed in until it is fully melted at which time the silane crosslinking agent is introduced until the torque is stabilized and the partial crosslinking reaction has been completed (ca. 10 min). The compound is then recovered and pressed into 1.5 mm thick plaques at 190° C. and under 100 bars for 1 min in a Colin hot press.

Process 3:

A partially crosslinked composition is prepared in a 46 mm/15D Buss Co-kneading extruder equipped with gravimetric feeding units. The screw rotation speed is set at 100 rpm and the total material throughput at 15 kg/h. The temperature profile is 160° C., 190° C., 210° C., 210° C. and 160° C. for the co-kneading barrel with a screw temperature set at 160° C. The discharge screw and die temperature are 170° C. and 180° C. respectively. The composition is prepared using a 2 pass process, where in the first pass the resin to be crosslinked is introduced with the peroxide and maleic anhydride to perform a grafting reaction to provide a maleic anhydride grafted resin which is then pelletized and used as such in the second pass (either recycled to the same extruder or sent to another extruder operating in tandem), where this resin is introduced with the matrix resin and the silane crosslinking agent at the same time. The resulting composition is then recovered in pellet form and pressed into 1.5 mm thick plaques at 190° C. and under 100 bars for 1 min in a Colin hot press.

### EXAMPLE 1

A partially crosslinked compound was prepared in accordance with process 1 set forth above using the following composition expressed as a percentage of the total formulation. All the reactive ingredients, peroxide, maleic anhydride and silane, were introduced in masterbatch form using 5% of the respective ingredients on porous Valtec 7153 XCS polypropylene carriers. The formulation was comprised of 74.8% of a HDPE polyethylene, Eltex 4040A (BP-Solvay), 0.05% di-tert-butyl peroxide (Trigonox B, Akzo), 0.1% maleic anhydride (MAH, Fluka), 17% of a polypropylene homopolymer matrix resin (Valtec 7153 XCS, Basell), 0.2% of tetrakis-methylene-(3,5-di-terbutyl-4-hydrocinnamate)methane (Irganox 1010, Ciba), and 0.25% of 4-amino-3,3-dimethylbutyl trimethoxysilane (Silquest A-1637, GE). The remainder of the formulation, 7.6%, was composed of the porous polypropylene (“PP”) carriers used.

### EXAMPLE 2

A partially crosslinked compound was prepared in accordance with process 1 using the following composition expressed as a percentage of the total formulation. All the reactive ingredients, peroxide, maleic anhydride and silane, were introduced in masterbatch form using 5% of the respective ingredients on porous Valtec 7153 XCS polypropylene carriers. The formulation is comprised of 74.8% of a HDPE polyethylene, Eltex 4040A (BP-Solvay), 0.05% di-tert-butyl peroxide (Trigonox B, Akzo), 0.1% maleic anhydride (MAH, Fluka), 17% of a polypropylene homopolymer matrix resin (Valtec 7153 XCS, Basell), 0.2% of tetrakis-methylene-(3,5-di-terbutyl-4-hydrocinnamate)methane (Irganox 1010, Ciba), and 0.25% of gamma-aminopropyl triethoxysilane (Silquest A-1100, GE). The-remainder of the formulation, 7.6%, was composed of the porous PP carriers used.

### EXAMPLE 3

A partially crosslinked compound was prepared following process 1 using the following composition expressed as a percentage of the total formulation. All the reactive ingredients, peroxide, maleic anhydride and silane, were introduced in masterbatch form using 5% of the respective ingredients on porous Valtec 7153 XCS polypropylene carriers. The formulation was comprised of 74.8% of a HDPE polyethylene, Lacqtene 2040 MN 55 (Atofina), 0.05% di-tert-butyl peroxide (Trigonox B, Akzo), 0.1% maleic anhydride (MAH, Fluka), 17% of a polypropylene homopolymer matrix resin (Valtec 7153 XCS, Basell), 0.2% of tetrakis-methylene-(3,5-di-terbutyl-4-hydrocinnamate)methane (Irganox 1010, Ciba), and 0.25% of gamma-aminopropyl triethoxysilane (Silquest A-1100, GE). The remainder of the formulation, 7.6%, was composed of the porous PP carriers used.

### EXAMPLE 4 (COMPARATIVE)

A non-crosslinked composition was prepared following process 1 using the following composition expressed in percent as a function of the total formulation: 74.8% of a HDPE polyethylene Eltex 4040A (BP-Solvay), 25% of a polypropylene homopolymer (Valtec 7153 XCS, Basell) and 0.2% oftetrakis-methylene-(3,5-di-terbutyl-4-hydrocinnamate)methane (Irganox 1010, Ciba). These components were mixed for a similar amount of time (ca. 10 min) compared to the above examples and resulted in a non-crosslinked blend of polymers.

### EXAMPLE 5

A partially crosslinked composition was prepared following process 2 using the following composition expressed as a percentage of the total formulation. All the reactive ingredients, peroxide, maleic anhydride and silane, were introduced in masterbatch form using 5% of the respective ingredients on porous Valtec 7153 XCS polypropylene carriers. First 74.8% of a HDPE polyethylene, Eltex 4040A (BP-Solvay) is introduced with 0.05% di-tert-butyl peroxide (Trigonox B, Akzo), 0.1% maleic anhydride (MAH, Fluka) and 2.7% of a polypropylene homopolymer (Valtec 7153 XCS, Basell). Then the matrix resin, 14.3% of a polypropylene homopolymer (Valtec 7153 XCS, Basell)was introduced with 0.2% of tetrakis-methylene-(3,5-di-terbutyl-4-hydrocinnamate)methane (Irganox 1010, Ciba), and finally 0.25% of gamma-aminopropyl triethoxysilane (Silquest A-1100, GE) was introduced. The remainder of the formulation, 7.6%, was composed of the porous PP carriers used.

Discussion of Test Results

All Examples above had a thermoplastic characteristic with respectively a melt flow index (MFI) at 190° C. with a 5 kg weight of 0.5, 1.7, 1.3, 2.3 and 1.7 g/10 min, respectively. These compositions were also characterized by enhanced thermo-mechanical resistances exemplified by their resistances to a hot-set test performed for 15 min at 140° C. under a stress of 0.6 MPa where Examples 1, 2, 3 and 5 respectively retain their integrity and have a permanent set of 75%, 70% and 60%. Under the same conditions the uncrosslinked composition of Comparative Example 4 broke. The enhanced thermo-mechanical resistance also results in retention of structural integrity of a 1.5 mm thick and 35 mm long dual cantilever sample subject to 80 um cyclic deformation in a dynamic-mechanical analysis (DMA) test ramped from 35° C. to 180° C. at 3° C./min. The typical modulus of Examples 1, 2, 3 and 4 at 180° C., beyond the melting temperature of both resins used, were measured at 10 to 15 MPa. The product produced by Example 5 on the other hand broke at 145° C. The general response of Examples 1, 2, 3 and 5 are similar to that of a standard PEX-b silane crosslinked polyethylene. Examples 1 and 2 show that different crosslinking agents can be used. Examples 2 and 3 show that different polymer resins can be used.

Examples 1, 2 and 3 exhibit a brittle character visible particularly in flexural fracture tests performed on the compression molded plaques. Example 4, on the other hand, showed no more brittle failures. Although not wishing to be bound by any theory, this later process uses a separate grafting step before blending with the polypropylene matrix resin that is believed to be subject to partial degradation when compounded in the presence of active peroxides. The tensile yield strength of Example 4 was measured at 50 mm/min to be of 20.3 MPa, its elongation to break reached 500%, and its gel content as measured according to EN579 was of 25%.

### EXAMPLE 6

A partially crosslinked composition was prepared following process 2 using the following composition expressed as a percentage of the total formulation. All the reactive ingredients, peroxide, maleic anhydride and silane, were introduced in masterbatch form using 5% of the respective ingredients on porous high density. polyethylene carriers (Pearlene 200HD, GE). First 71.8% of a HDPE polyethylene, Eltex 4040A (BP-Solvay) is introduced with 0.05% di-tert-butyl peroxide (Trigonox B, Akzo) and 0.1% maleic anhydride (MAH, Fluka). Then the matrix resin, 20% of a PE80 polyethylene (Finathene 3802, Atofina) was introduced with 0.2% of tetrakis-methylene-(3,5-di-terbutyl-4-hydrocinnamate)methane (Irganox 1010, Ciba), and finally 0.25% of gamma-aminopropyl triethoxysilane (Silquest A-1100, GE) was introduced. The remainder of the formulation, 7.6%, is composed of the porous HDPE carriers used.

### EXAMPLE 7

A partially crosslinked compound was prepared following process 3 using the following composition expressed as a percentage of the total formulation. All the reactive ingredients, peroxide, maleic anhydride and silane, were introduced in masterbatch form using 5% of the respective ingredients on porous high density polyethylene carriers (Pearlene 200HD, GE). The first grafting pass consisted of 72% of a HDPE polyethylene, Eltex 4040A (BP-Solvay), 0.05% di-tert-butyl peroxide (Trigonox B, Akzo) and 0.1% maleic anhydride (MAH, Fluka). This grafted compound is pelletized and introduced with the matrix resin, 20% of a PE80 polyethylene (Finathene 3802, Atofina) and 0.25% of gamma-aminopropyl triethoxysilane (Silquest A-1100, GE) in the second pass. The remainder of the formulation, 7.6%, was composed of the porous HDPE carriers used.

### EXAMPLE 8

A partially crosslinked composition is prepared following process 3 using the following composition expressed in percent as a function of the total formulation. All the reactive ingredients, peroxide, maleic anhydride and silane, were introduced in masterbatch form using 5% of the respective ingredients on porous high density polyethylene carriers (Pearlene 200HD, GE). The first grafting pass consisted of 72.6% of a HDPE polyethylene, Eltex 4040A (BP-Solvay), 0.04% di-tert-butyl peroxide (Trigonox B, Akzo) and 0.08% maleic anhydride (MAH, Fluka). This grafted compound was pelletized and introduced with the matrix resin, 21% of a PE80 polyethylene (Finathene 3802, Atofina) and 0.2% of gamma-aminopropyl triethoxysilane (Silquest A-1100, GE) in the second pass. The remainder of the formulation, 6.08%, was composed of the porous HDPE carriers used.

### EXAMPLE 9 (COMPARATIVE)

A partially crosslinked compound was prepared following process 3 using the following composition expressed as a percentage of the total formulation. All the reactive ingredients, peroxide, maleic anhydride and silane, were introduced in masterbatch form using 5% of the respective ingredients on porous high density polyethylene carriers (Pearlene 200HD, GE). The first grafting pass consisted of 73.5% of a HDPE polyethylene, Eltex 4040A (BP-Solvay), 0.025% di-tert-butyl peroxide (Trigonox B, Akzo) and 0.05% maleic anhydride (MAH, Fluka). This grafted compound was pelletized and introduced with the matrix resin, 22.5% of a PE80 polyethylene (Finathene 3802, Atofina) and 0.125% of gamma-aminopropyl triethoxysilane (Silquest A-1100, GE) in the second pass. The remainder of the formulation, 3.8%, was composed of the porous HDPE carriers used.

Discussion of Test Results:

Examples 6 and 7 were partially crosslinked compounds with similar properties that show that both the Brabender laboratory and pilot scale Buss-kneader processes are applicable. The pilot scale process however yielded a slightly better crosslinking efficiency. Typical properties were respectively a gel content of 17% and 22%, a MFI of 0.95 and 0.35 g/10 min, a yield strength of 20.7 and 17.6 MPa, an elongation to break of 746% and 1043%, and a DMA dual cantilever beam modulus of 11 and 10.5 MPa.

Examples 7, 8 and 9 illustrate the effect of varying the ratio of reactive components used. Example 9, using the least amount of reactive components, performed as a non-crosslinked compound (such as Comparative Example 4) and thus failed in the above described hot-set test and DMA test despite a measured gel content of 5%. Example 8 had mechanical properties similar to Example 7 and also passes the DMA test with a retained modulus at 180° C. of 10.5 MPa despite a low measured gel content of 12%.

### EXAMPLE 10

A partially crosslinked compound was prepared following process 3 but using a Buss Co-kneader of 46 mm/11D. The screw rotation speed was set at 160 rpm and the total material throughput at 12 kg/h. The temperature profile used was 210° C. and 170° C. for the co-kneading barrel with a screw temperature set at 80° C. The discharge screw and die temperature were of 200° C. and 210° C. respectively. The following composition expressed in percent as a function of the total formulation has been used. All the reactive ingredients, peroxide, maleic anhydride and silane, were introduced in masterbatch form using 5% of the respective ingredients on porous high density polyethylene carriers (Pearlene 200HD, GE). The first grafting pass consisted of 72.3% of a HDPE polyethylene, Eltex 4040A (BP-Solvay), 0.045% di-tert-butyl peroxide (Trigonox B, Akzo) and 0.09% maleic anhydride (MAH, Fluka). This grafted compound was pelletized and introduced with the matrix resin, 18.5% of a PE80 polyethylene (Finathene 3802, Atofina), 0.225% of gamma-aminopropyl triethoxysilane (Silquest A-1100, GE) and 2% of a Eltex 4040A based antioxidant masterbatch (UX1, GE) in the second pass. The remainder of the formulation, 6.84%, is composed of the porous HDPE carriers used.

Discussion of Test Results

The partially crosslinked compound of Example 10 had a total gel content of 22% as measured according to EN579. This yields to the product an enhanced thermo-mechanical resistance as shown by the retention of a structural integrity in a DMA test as described above. The product showes a DMA trace very close to that of a standard crosslinked polyethylene, which has gel contents of at least 60%, and has a modulus retention of about 10 MPa beyond the standard HDPE melting temperature and up to at least 180° C.

To further illustrate the thermo-mechanical resistance and partial crosslinking effect, a sample cold drawn to 1000% elongation has been subjected to a heat treatment at 210° C. in an air-circulating oven. This treatment resulted in shrinkage due to a shape memory effect typical of crosslinked materials and the final elongation after heat exposure, corresponding to a permanent set, of the 1000% elongated tensile dog-bone specimen was of only 50%. Finally, the thermo-mechanical properties were also illustrated by a resistance to a hot-knife test performed at 140° C. Under such temperatures, even high thermal resistant polyethylenes deform and were cut by the hot-knife. The composition of Example 10 on the other hand was hardly indented by the knife. The mechanical performances at room temperature of the composition were also excellent. The tensile yield strength, tensile strength at break and elongation at break measured at a crosshead rate of 50 mm/min were respectively 20.0 MPa, 30.0 MPa and 1050%.

The MFI of this resin was at 190° C. with 5 kg of 0.2 g/10 min. Although this is rather low, it allows to manufacture good quality pipe at normal extrusion conditions. Pipe specimens of 16×2 mm were manufactured using this compound on a laboratory BC38 Davis-Standard pipe extrusion line using a standard temperature profile for HDPE pipes. This pipe was subjected to a short-term hydraulic pressure strength (Burst) according to ASTM D1599-99e1 at 3 different temperatures. The specimens were ramped to burst in 60 to 70 seconds at 23° C., 82° C. and 93° C. The respective obtained burst pressure resistances were of 23.7 MPa, 8.73 MPa and 7.14MPa. The compound processability also allows it to be injection molded under standard conditions as has been evaluated using an Arburg-Allrounder 320-210-750 injection molding unit. This allows use of such partially crosslinked compounds for the manufacturing of pipe fittings as well. Since these are in many cases preferably welded to the pipes, weldability of the composition of Example 10 was also evaluated. Pipe samples of 200 mm length were cut in half and tested for butt welding. The cut surfaces were put in contact with a welding heater set at a temperature of 210° C. under a pressure of 0.15 MPa during 90 seconds. The heated pipe surfaces were then put in contact, after a change over time of about 3 seconds, under a pressure of 0.5 MPa maintained during 30 seconds. After being cooled, tensile dog-bone specimens were cut from the welded pipe using a sample puncher. Tensile tests were then made at 23° C. at a crosshead rate of 20 mm/min. The tensile yield strength and elongation to break of the welded bars were 18.4 MPa and 600% respectively.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A method for making a polymer blend comprising:
blending a thermoplastic polymer, a grafted polyolefin, a moisture source, and a crosslinking agent in a mixing zone to provide a thermoplastic polymer blend including a matrix phase of the thermoplastic polymer, a reinforcing phase of the at least partially crosslinked polyolefin, and having a gel content of from about 10% to about 50% by weight.

2. The method of claim 1 wherein the grafted polyolefin is provided by reaction of an ethylene polymer with a carboxylic anhydride and a free radical generator.

3. The method of claim 2 wherein the ethylene polymer is reacted with the carboxylic anhydride and free radical generator prior to blending in the mixing zone.

4. The method of claim 2 wherein the ethylene polymer is reacted with the carboxylic anhydride and free radical generator within the mixing zone to provide the grafted polyolefin in situ.

5. The method of claim 1 wherein the reinforcing phase of the thermoplastic polymer blend comprises partially crosslinked polyolefin.

6. The method of claim 5 wherein the partially crosslinked ethylene polymer is provided by selectively crosslinking pre-grafted ethylene polymer in the mixing zone.

7. The method of claim 5 wherein the pre-grafted ethylene polymer is provided in the mixing zone by combining ethylene polymer with a carboxylic anhydride and free radical generator and subjecting the ethylene polymer to a grafting reaction for a predetermined period of time prior to combination with the crosslinking agent.

8. The method of claim 7 comprising discharging the pre-grafted ethylene polymer from the mixing zone, then feeding the grafted ethylene polymer together with thermoplastic polymer back into the same or different mixing zone along with at least one silane.

9. The method of claim 1 wherein the thermoplastic polymer comprises one or more of polyethylene, polypropylene, polystyrene, acrylonitrile butadiene styrene, styrene acrylonitrile, polymethylmethacrylate, thermoplastic polyesters, polycarbonate, polyamide, PPE and physical or chemical combinations thereof.

10. The method of claim 7 wherein the carboxylic anhydride comprises one or more compounds from the group consisting of isobutenylsuccinic, (±)-2-octen-1-ylsuccinic, itaconic, 2-dodecen-1-ylsuccinic, cis-1,2,3,6-tetrahydrophthalic, cis-5-norbomene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic, bromomaleic and dichloromaleic anhydrides.

11. The method of claim 7 wherein the free-radical generators is selected from the group consisting of hydrogen peroxide, ammonium persulfate, potassium persulfate, various organic peroxy catalysts, such as dialkyl peroxides, e.g., diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane; 2,5-dimethyl-2,5-di(t-butylperoxy)hexane, 2,5-dimethyl-2,5-di(t-butylperoxy)hexyne-3; dicumyl peroxide, alkyl hydrogen peroxides such as t-butyl hydrogen peroxide, t-amyl hydrogen peroxide, cumyl hydrogen peroxide, diacyl peroxides, for instance acetyl peroxide, lauroyl peroxide, benzoyl peroxide, ethyl peroxybenzoate and 2-azobis(isobutyronitrile).

12. The method of claim 1 wherein the moisture source is water.

13. The process of claim 1 wherein the moisture source comprises a hydrated inorganic compound.

14. The process of claim 13 wherein the hydrated inorganic compound is selected from the group consisting of Al(OH)₃, Mg(OH)₂ and Ca(OH)₂.

15. The process of claim 1 wherein the crosslinking agent is a silane having the formula
YNHBSi(OR)ₐ(X)₃₋ₐ,
wherein a=1 to 3, Y is hydrogen, an alkyl, alkenyl, hydroxy alkyl, alkaryl, alkylsilyl, alkylamine, C(═O)OR or C(═O)NR, R is an acyl, alkyl, aryl or alkaryl, X is R or a halogen wherein R is methyl or ethyl, B is a divalent straight chain, branched chain or cyclic hydrocarbon bridging group, or B may contain heteroatom bridges.

16. The process of claim 15 wherein R is methyl, Y is an amino alkyl, hydrogen, or alkyl, and X is Cl or methyl.

17. The process of claim 1 wherein the crosslinking agent is a silane selected from the group consisting of gamma-amino propyl trimethoxy silane, gamma-amino propyl triethoxy silane, gamma-amino propyl methyl diethoxy silane, 4-amino-3,3-dimethyl butyl triethoxy silane, 4-amino-3,3-dimethyl butyl methylediethoxysilane, N-beta-(aminoethyl)-gamma-aminopropyltrimethoxysilane, H₂NCH₂CH₂NHCH₂CH₂NH(CH₂)₃Si(OCH₃)₃, N-beta-(aminoethyl)-gamma-aminopropylmethyldimethoxysilane, 3-(N-allylamino) propyltrimethoxysilane, 4-aminobutyltriethoxysilane, 4-aminobutyltrimethoxysilane, (aminoethylaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl] ethylenediamine, N-methylaminopropyltrimethoxysilane, bis-(gamma-triethoxysilylpropyl)amine, N-phenyl-gamma-aminopropyltrimethoxysilane, N-ethyl-gamma-aminoisobutyltrimethoxysilane, 4-amino-3,3-dimethylbutyltrimethoxysilane, 4-amino-3,3-dimethylbutyldimethoxysilane, tert-butyl-N-(3-trimethoxysilylpropyl)carbamate, ureidopropyltriethoxysilane and ureidopropyltrimethoxysilane.

18. The method of claim 1 further comprising blending at least one additive selected from the group consisting of stabilizers, pigments, fillers and processing aids.

19. The method of claim 1 further comprising discharging the thermoplastic polymer blend from the mixing zone.

20. The method of claim 19 further comprising forming the discharged thermoplastic polymer blend into a tubular conduit.

21. A method for making a polymer blend comprising:
a) combining a thermoplastic first polymer, a thermoplastic second polymer, a carboxylic anhydride, a free radical generator, and a crosslinking agent in a mixing zone;
b) reacting the thermoplastic second polymer with the carboxylic anhydride and free radical generator to provide a grafted polymer;
c) reacting the crosslinking agent with the grafted polymer to provide an at least partially crosslinked polymer; and,
d) blending the thermoplastic first polymer and the at least partially crosslinked polymer to provide a polymer blend having a matrix phase of thermoplastic first polymer and a reinforcing phase of the at least partially crosslinked polymer.

22. The method of claim 21 wherein the thermoplastic first polymer is polypropylene and the thermoplastic second polymer is polyethylene.

23. The method of claim 21 wherein both the thermoplastic first polymer and thermoplastic second polymer are polyethylene.

24. A method for making a fluid conduit comprising:
a) blending a thermoplastic first polymer and at least a partially crosslinked second polymer to provide a polymer blend including a matrix phase of the thermoplastic first polymer, a reinforcing phase of the at least partially crosslinked second polymer, and having a gel content of from about 10% to about 50% by weight; and
b) forming said polymer blend into a tubular conduit.

25. The method of claim 24 wherein the thermoplastic first polymer comprises polyethylene and the at least partially crosslinked second polymer comprises polyethylene.

26. The method of claim 24 wherein the second polymer is crosslinked by radiation or chemical crosslinking.

27. The method of claim 24 wherein the crosslinked second polymer is provided by reacting polyethylene with a carboxylic anhydride and a peroxide to provide a grafted polyethylene, then reacting the grafted polyethylene with a silane in the presence of a moisture source.
